(19) United States
(12) Patent Application Publication
(10) Pub. No.: US 2014/0214847 A1
(43) Pub. Date: Jul. 31, 2014

(54) INFORMATION RECOMMENDATION METHOD AND SYSTEM BASED ON MESSAGE CONTENT

(71) Applicant: BEIJING NETQIN TECHNOLOGY CO., LTD., Beijing (CN)

(72) Inventors: Yaowei Chen, Beijing (CN); Xianwei Meng, Beijing (CN); Yu Lin, Beijing (CN); Shihong Zou, Beijing (CN)

(21) Appl. No.: 14/129,693

(22) PCT Filed: Sep. 24, 2012
(86) PCT No.: PCT/CN2012/081835

§ 371 Date: Dec. 27, 2013

(30) Foreign Application Priority Data
Sep. 26, 2011 (CN) 201110287538.1

(51) Int. Cl. G06F 17/30

(52) U.S. Cl. CPC G06F 17/30598
USPC 707/740

(57) ABSTRACT

The present disclosure provides an information recommendation method and system based on message content. The method comprises the following steps: when a message is viewed at a user side, providing a guiding option to a user; if the user triggers the guiding option, then performing single-level classification or multi-level classification on the message to obtain category information; and a server returning information related to the category information to the user side.

### TECHNICAL FIELD

The present disclosure relates to an information recommendation method to and system, and in particular, to an information recommendation method and system based on message content.

### BACKGROUND

With the development of the information technology, people have is increasing requirements on a variety of information, and the information provider also wants to provide information thereof to users through an effective channel, so as to achieve purposes such as commodity recommendation, enterprise propaganda, information promotion etc. People want to receive information which matches with their own requirements as much as possible, thereby avoiding disturbance of a large amount of unwanted “spam information”, while the information provider wishes to provide targeted information to target population, thus enhancing recommendation efficiency, saving cost, and increasing satisfaction of users.

However, the matching degree between the information provided by the current information recommendation method and system and the requirements of the user is far from enough, and thus it is difficult to achieve the above purpose. Therefore, there is a need for an information recommendation method and system capable of providing information, which accurately matches with the requirements of the user.

### SUMMARY

The purpose of the present disclosure is to provide an information recommendation method and system based on message content, which can analyze the message content received by a user and obtain a category to which the message belongs and corresponding potential requirements of the user, thereby recommending targeted related information based thereon. On one hand, the system provides interested information to the user, and on the other hand, the system creates an information provision platform with accurate localization for a seller, which can largely reduce the antipathy of the user and improve the conversion rate of the user from viewing an advertisement to purchasing a commodity.

According to an aspect of the present disclosure, an information recommendation method based on message content is provided, which comprises the following steps:

A) providing a guiding option to a user when a message is viewed at a user side;

B) if the user triggers the guiding option, performing single-level classification or multi-level classification on the message to obtain category information; and

C) the server returning information related to the category information to the user side.

In an embodiment, the multi-level classification includes two-level classification, which comprises:

B1) pre-processing the message to remove noise information; and

B2) judging a transmission number of the message, and if a first-level category of the message is determined after the judgment, performing a second-level category judgment, which comprises:
scanning the message by using keywords corresponding to respective second-level categories of the determined first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and

if a weighted sum of a certain second-level category reaches or exceeds a threshold value set for the second-level category, determining that the message belongs to the second-level category.

In an embodiment, the multi-level classification includes two-level classification, which comprises:

B1) pre-processing the message to remove noise information; and

B2) judging a transmission number of the message, and if a first-level category of the message cannot be determined after the judgment of the transmission number of the message, performing the following judgment which comprises:
scanning the message by using all keywords in turns according to an order of respective first-level categories to find keywords of the first-level categories contained in the message;
calculating a sum of weighted values of keywords corresponding to respective first-level categories in the message as a weighted sum of the respective first-level categories, wherein, repeated keywords are omitted and
if a weighted sum of a certain first-level category reaches or exceeds a threshold value set for the first-level category, determining that the message belongs to the first-level category, and performing a second-level category judgment,

wherein, the second-level category judgment comprises:
scanning the message by using keywords corresponding to respective second-level categories of the determined first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and

if a weighted sum of a certain second-level category reaches or exceeds a threshold value set for the second-level category, determining that the message belongs to the second-level category.

In an embodiment, the multi-level classification includes two-level classification, which comprises:

B1) pre-processing the message to remove noise information; and

B2) judging a transmission number of the message, and if a first-level category of the message is determined after the judgment, performing a second-level category judgment, which comprises:
scanning the message by using keywords corresponding to respective second-level categories of the determined first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and

if a weighted sum of a certain second-level category reaches or exceeds a threshold value set for the second-level category, determining that the message belongs to the second-level category.

In an embodiment, the multi-level classification includes two-level classification which comprises:

B1) pre-processing the message to remove noise information; and

B2) judging a transmission number of the message, and if a first-level category of the message cannot be determined after the judgment of the transmission number of the message, performing the following judgment which comprises:
in the process of scanning the message by using all keywords in turns according to an order of respective first-level categories, simultaneously calculating a sum of weighted values of keywords corresponding to respective first-level categories in the message, which have been obtained by scanning, as a weighted sum of the respective first-level categories;
once a weighted sum of a certain first-level category reaches or exceeds a threshold value set for the first-level category, determining that the message belongs to the first-level category and stopping the scanning at the same time, thus completing the judgment of the first-level category and performing a second-level category judgment; and
if there is no weighted sum of a first-level category that reaches or exceeds the threshold value set for the first-level category, determining that the message belongs to another category, and the second-classification ending,

wherein, the second-level category judgment comprises:
scanning the message by using keywords corresponding to respective second-level categories of the determined first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and

if a weighted sum of a certain second-level category reaches or exceeds a threshold value set for the second-level category, determining that the message belongs to the second-level category.

In an embodiment, the keywords, the weighted values and the threshold values can be selected and set by manually analyzing a number of messages in advance.

In an embodiment, the keyword is numbered to represent its category and weighted value.

In an embodiment, the message and the information have different data formats.

According to another aspect of the present disclosure, an information recommendation system based on message content is provided, which comprises a user side apparatus and a server side apparatus, wherein, the user side apparatus comprises a user side receiving module, a user side interface, a guiding module, an analyzing module and a user side transmitting module, and the sever side apparatus comprises a server side receiving module, a server side transmitting module and a database; when a message is viewed on the user side apparatus, the guiding module provides a guiding option and displays the guiding option on the user side interface, and if a user triggers the guiding option, a classifier in the analyzing module starts to perform single-level classification or multi-level classification on the message to obtain category information, and the user side transmitting module transmits the category information to the server side apparatus; and the sever side receiving module receives the category information, and information related to the category information in the database is returned to the user side apparatus by the server side transmitting module.

In an embodiment, the classifier performs two-level classification on the message, wherein a keyword and category information corresponding to the keyword are pre-loaded in the classifier, after the message enters the classifier, the message is pre-processed firstly to remove noise information in the message, then a transmission number of the message is judged, and if a first-level category of the message is determined after the judgment, a second-level category of the message continues to be determined,

wherein, determining the second-level category of the message comprises:
scanning the message by using keywords corresponding to respective second-level categories of the first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and

if a weighted sum of a certain second-level category reaches or exceeds a threshold value set for the second-level category, determining that the message belongs to the second-level category.

In an embodiment, the classifier performs two-level classification on the message, wherein a keyword and category information corresponding to the keyword are pre-loaded in the classifier, after the message enters the classifier, the message is pre-processed firstly to remove noise information in the message, then a transmission number of the message is judged, and if a first-level category of the message cannot be determined after the judgment of the number of the message, the message is scanned by using all keywords in turns according to an order of respective first-level categories, a sum of weighted values of keywords corresponding to respective first-level categories in the message is calculated as a weighted sum of the respective first-level categories, and if a weighted sum of a certain first-level category reaches or exceeds a threshold value set for the first-level category, it is determined that the message belongs to the first-level category; after the first-level category of the message is determined, a second-level category is then determined, and if there is no weighted sum of a first-level category that reaches or exceeds the threshold value set for the first-level category, it is determined that the message belongs to another category, and

wherein, determining the second-level category comprises:
scanning the message by using keywords corresponding to respective second-level categories of the first-level category to find keywords of second-level categories contained in the message;
according to a weighted value of each keyword, calculating a sum of weighted values of the keywords corresponding to the respective second-level categories in the message used as a weighted sum of the respective second-level categories, wherein, repeated keywords are omitted; and

if a weighted sum of a certain second-level category reaches or exceeds a threshold value set for the second-level category, determining that the message belongs to the second-level category.

In an embodiment, the user side transmitting module assembles, compresses and encrypts the category information of the message and user related information to obtain transmitted data, then transmits the transmitted data to the server side apparatus over a network, after receiving the data, the sever side receiving module decrypts, decompresses and parses the transmitted data correspondingly to obtain the category information and the user related information, searches in the database according to the category information to obtain a plurality of pieces of information corresponding to the category information, the server side transmitting module assembles, compresses and encrypts the plurality of pieces of information and transmits the information to the user side apparatus over the network, and the user side receiving module obtains the plurality of pieces of information by corresponding decrypting, decompressing and parsing, and displays the information on the user side interface.

According to another aspect of the present disclosure, an information recommendation system based on message content is provided, which comprises a user side apparatus and a server side apparatus, wherein, the user side apparatus comprises a user side receiving module, a user side interface, a guiding module and a user side transmitting module, and the sever side module comprises a server side receiving module, an analyzing module, a server side transmitting module and a database; the guiding module provides a guiding option to a user and displays the guiding option on the user side interface; when the user triggers the guiding option, the user side transmitting module transmits the message content to the server side apparatus; the analyzing module of the server side apparatus comprises a classifier, which performs single-level classification or multi-level classification on the message to obtain category information, and the server side transmitting module returns information related to the category information in the database to the user side apparatus.

In an embodiment, the classifier performs two-level classification on the message, wherein a keyword and category information corresponding to the keyword are pre-loaded in the classifier, after the message enters the classifier, the message is pre-processed firstly to remove noise information in the message, then a transmission number of the message is judge, and if a first-level category of the message is determined after the judgment, a second-level category of the message continues to be determined,

wherein, determining the second-level category of the message comprises:
scanning the message by using keywords corresponding to respective second-level categories of the first-level category to find the keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and

if a weighted sum of a certain second-level category reaches or exceeds a threshold value set for the second-level category, determining that the message belongs to the second-level category.

In an embodiment, the classifier performs two-level classification on the message, wherein a keyword and category information corresponding to the keyword are pre-loaded in the classifier, after the message enters the classifier, the message is pre-processed firstly to remove noise information in the message, then a transmission number of the message is judged, and if a first-level category of the message cannot be determined after the judgment of the number of the message, in the process of scanning the message by using all keywords in turns according to an order of respective first-level categories, a sum of weighted values of keywords corresponding to respective first-level categories in the message, which have been obtained by scanning, is calculated simultaneously as a weighted sum of the respective first-level categories, once a weighted sum of a certain first-level category reaches or exceeds a threshold value set for the first-level category, it is determined that the message belongs to the first-level category and the scanning is stopped at the same time, thus completing the judgment of first-level category, and after the first-level category of the message is determined, a second-level category is then determined, and if there is no weighted sum of a first-level category that reaches or exceeds the threshold value set for the first-level category, it is determined that the message belongs to another category, and

wherein, determining the second-level category comprises:
scanning the message by using keywords corresponding to respective second-level categories of the first-level category to find the keywords of the second-level categories contained in the message;
according to a weighted value of each keyword, calculating a sum of weighted values of the keywords corresponding to the respective second-level categories in the message as a weighted sum of the respective second-level categories, wherein, repeated keywords are not calculated; and

if a weighted sum of a certain second-level category reaches or exceeds a threshold value set for the second-level category, determining that the message belongs to the second-level category.

In an embodiment, the user side transmitting module assembles, compresses and encrypts the message content and user related information to obtain transmitted data, then transmits the transmitted data to the server side apparatus over a network, after receiving the data, the sever side receiving module decrypts, decompresses and parses the transmitted data correspondingly to determine the category information and the user related information, searches in the database according to the category information to obtain a plurality of pieces of information corresponding to the category information, the server side transmitting module assembles, compresses and encrypts the plurality of pieces of information and transmits the information to the user side module over the network, and the user side receiving apparatus obtains the plurality of pieces of information by corresponding decrypting, decompressing and parsing, and displays the information on the user side interface.

### BRIEF DESCRIPTION OF THE DRAWINGS

FIG. 1 shows a block diagram of an embodiment of an information recommendation system based on message content according to the present disclosure;

FIG. 2 shows an operational flowchart of one embodiment of the information recommendation system based on message content according to the present disclosure as illustrated in FIG. 1;

FIG. 3 shows a block diagram of another embodiment of an information recommendation system based on message content according to the present disclosure;

FIG. 4 shows an operational flowchart of another embodiment of the information recommendation system based on message content according to the present disclosure as illustrated in FIG. 3;

FIG. 5 shows an operational flowchart of performing two-level classification on a message in a classifier of an analyzing module at a user side;

FIG. 6 shows a diagram of correspondences between information returned by a server side apparatus and message categories of a user side;

FIG. 7 shows an exemplary flowchart of an embodiment of data interaction between a user side apparatus and a server side apparatus;

FIG. 8 shows an exemplary flowchart of another embodiment of data interaction between a user side apparatus and a server side apparatus; and

FIG. 9 shows a flowchart of an information recommendation method based on message content according to the present disclosure.

### DETAILED DESCRIPTION OF THE EMBODIMENTS

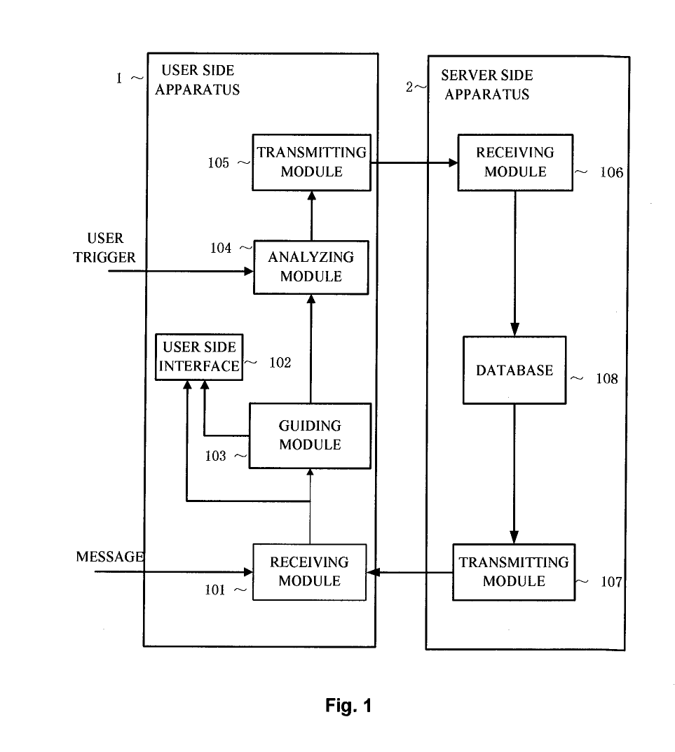

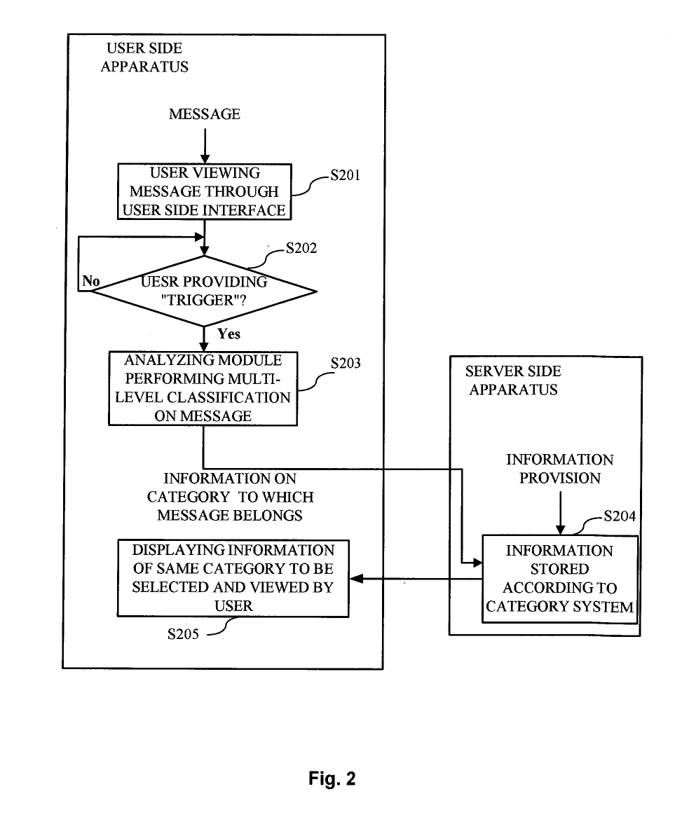

FIG. 1 shows a block diagram of an embodiment of an information recommendation system based on message content according to the present disclosure. The system includes a user side apparatus 1 and a server side apparatus 2. The user side apparatus 1 includes a receiving module 101, a user side interface 102, a guiding module 103, an analyzing module 104 and a transmitting module 105. FIG. 2 shows an operational flowchart of one embodiment of an information recommendation system based on message content according to the present disclosure as illustrated in FIG. 1. When a message is viewed on the user side apparatus 1, the guiding module 103 will provide a guiding option such as “I am interested” or “View information of the same category” and display the guiding option on the user side interface 102 (S201), and determine whether the user will trigger the guiding option (S202). If the user is indeed interested and applies a “trigger” action (for example, clicking on the guiding option), in response to the trigger action, the analyzing module 104 starts to analyze the message. Optionally, the “trigger” is not limited to an action, for example, if a user remains in a short message reading state for more than 3 minutes, the guiding option is triggered. The information (including message content, a transmission number etc.) contained in the message may be transferred into a classifier in the analyzing module 104, and the classifier may perform single-level classification or multi-level classification (S203), to determine a multi-level category to which the message belongs, and with the increase of the number of category levels, the classification standard is gradually refined. For example, two-level classification may be performed on the message, to determine single-level category and second-level category to which the message belongs. The single-level category primarily corresponds to a field of the message content, and the second-level category primarily corresponds to requirements based refinement. Under each single-level category, there is a large amount of corresponding second-level category. Then, the user side apparatus 1 transmits the category information output by the classifier to the server side apparatus 2 through the transmitting module 105.

The server side apparatus 2 comprises a receiving module 106, a transmitting module 107 and a database 108. All kinds of information provided by the information provider is classified and stored in the database 108, which has complete category system division, according to respective categories and requirements. The receiving module 106 receives category information of the user side apparatus 1, and several pieces of information (possibly including the information itself or corresponding links) related to the category in the database 108 is returned to the user side apparatus 1 by the transmitting module 107 (for example, S204 in FIG. 2). The user side apparatus presents information of the same category to be viewed by the user (for example, S205 in FIG. 2), thereby finally completing information recommendation.

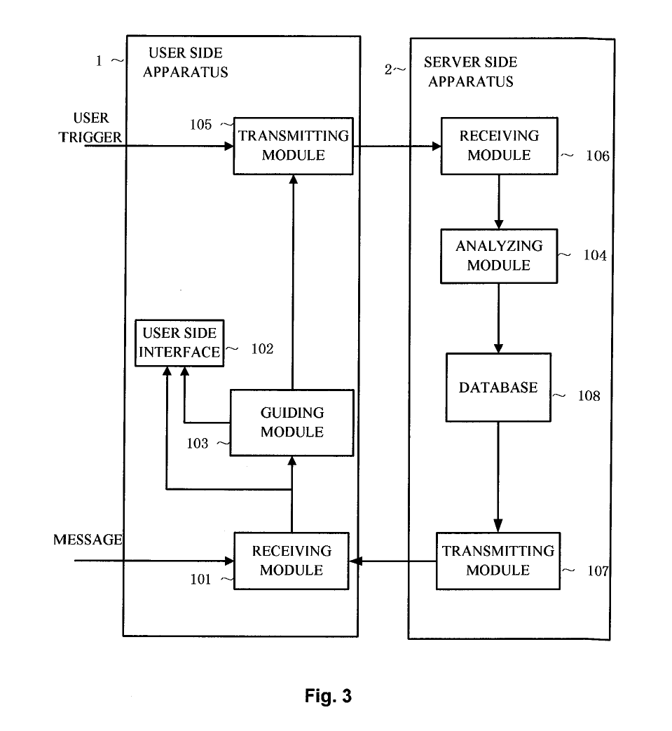

FIG. 3 shows a block diagram of another embodiment of an information recommendation system based on message content according to the present disclosure. The difference from the embodiment illustrated in FIG. 1 is that the analyzing module 104 is located in the server side apparatus 2. That is, the user side apparatus 1 includes a receiving module 101, a user side interface 102, a guiding module 103 and a transmitting module 105, and the server side apparatus 2 includes a receiving module 106, an analyzing module 104, a transmitting module 107 and a database 108.

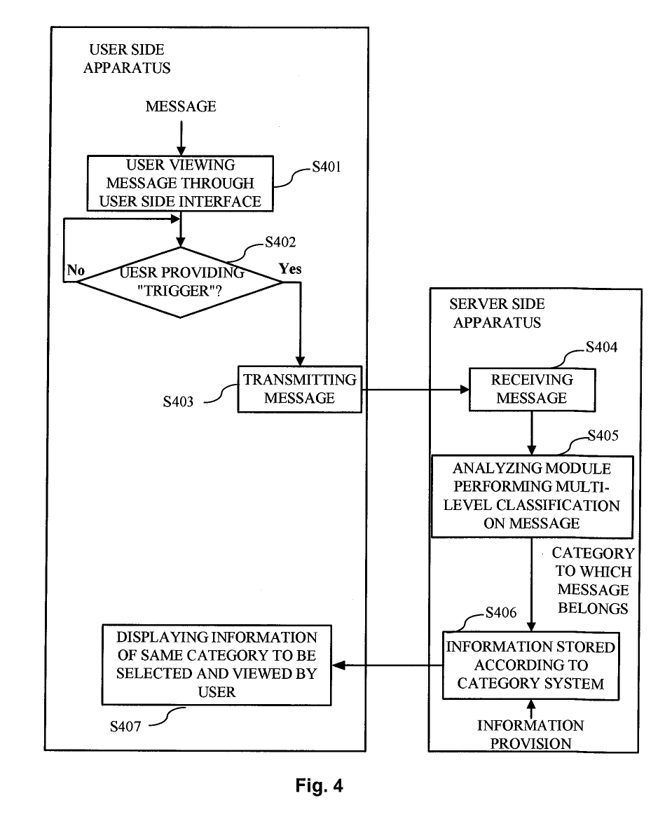

FIG. 4 shows an operational flowchart of another embodiment of the information recommendation system based on message content according to the present disclosure as illustrated in FIG. 3. The guiding module 103 provides a guiding option to the user and displays the guiding option on the user side interface 102 (S401), and determines whether the user triggers the guiding option (S402). When the user triggers the guiding option, the transmitting module 105 at the user side transmits message content to the server side apparatus 2 (S403). The receiving module 106 of the server side apparatus 2 receives the message content (S404). The analyzing module 104 of the server to side apparatus includes a classifier, which performs single-level classification or multi-level classification on the message (S405), to obtain category information. The server side transmitting module 107 returns information in the database corresponding to the category information to the user side apparatus (S406). The user side apparatus presents information of the same category to be viewed by the user (S407), thereby finally completing information recommendation.

For sake of simplification, specific embodiments of an operation of the classifier are described below by taking two-level classification as an example. Those skilled in the art should understand that the method and system described in the present disclosure may be extended to the multi-level classification with more than two levels.

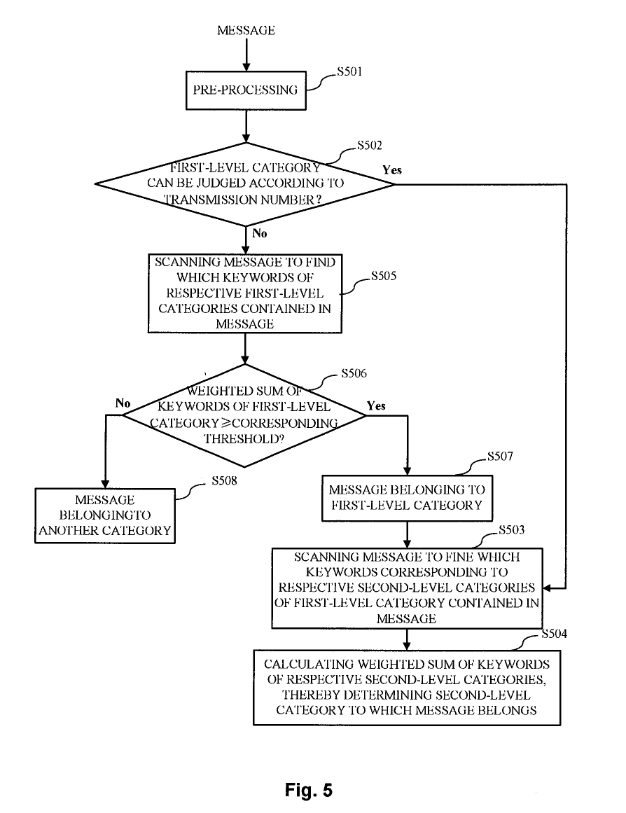

FIG. 5 shows an operational flowchart of performing two-level classification on a message in the classifier of the analyzing module 104 at the user side apparatus 1. A keyword and its corresponding category information have been pre-loaded in the classifier. After the message enters the classifier, the message is pre-processed firstly (S501), for example, “noise information” such as punctuations is removed. A transmission number of the message is then judged (S502), and if a first-level category of the message is determined after the judgment (i.e., the judgment result of S502 is “Yes”), the message is scanned by using keywords corresponding to respective second-level categories of the first-level category (S503). The essence of the scanning process is to find keywords of the second-level categories contained in the message (repeated keywords are omitted). For example, if the transmission number of the message is a transmission number of a bank category (usually 955* or 106*955*), after the judgment, it can be known that the first-level category of the message belongs to the “bank category”. The message is then scanned by using keywords corresponding to second-level categories of the first-level category (bank category), such as “financial management”, “credit card” etc.

Each keyword has a weighted value. After the scanning, a sum of weighted values of keywords corresponding to respective second-level categories in the message is calculated as a weighted sum of the respective second-level categories. If a weighted sum of a certain second-level category reaches or exceeds a threshold value set for the second-level category, it is determined that the message belongs to the second-level category (S504).

If the first-level category of the message cannot be determined after the judgment of the number of the message (i.e., the judgment result of S502 is “No”), the following judgment may be made. The message may be scanned by using all keywords in turn according to an order of respective first-level categories to find which keywords of respective first-level categories are contained in the message (repeated keywords are omitted) (S505). A sum of weighted values of the keywords corresponding to respective first-level categories in the message is calculated as a weighted sum of the respective first-level categories. It is judged whether a weighted sum of a certain first-level category reaches or exceeds a threshold value set for the first-level category (S506). If the weighted sum of the certain first-level category reaches or exceeds a threshold value set for the first-level category (i.e., the judgment result of S506 is “Yes”), it is determined that the message belongs to the first-level category (S507). If there is no weighted sum of a first-level category that reaches or exceeds the threshold value set for the first-level category (i.e., the judgment result of S506 is “No”), it is determined that the message belongs to another category (S508). After the first-level category of the message is determined, the second-level category of the message is determined by a process which is the same as the process of determining the second-level process described above (i.e., steps S503 and S504) to obtain final classification information for the message.

Preferably, the keywords and their weighted values as well as threshold values of respective first-level categories and second-level categories may be selected and set by manually analyzing a large amount of information in advance. Preferably, respective keywords may be numbered for facilitating analysis.

Preferably, in the process of scanning the message by using all keywords in turns according to an order of the respective first-level categories, a sum of the weighted values of keywords corresponding to respective first-level categories in the message, which have been obtained by scanning, may be calculated simultaneously as a weighted sum of the respective first-level categories. Once a weighted sum of a certain first-level category reaches or exceeds a threshold value set for the first-level category, it is determined that the message belongs to the first-level category and the scanning is stopped at the same time, thereby completing the judgment of first-level category while shortening the time required by the judgment.

As an example, Table 1 gives a kind of a classification system for two-level classification, wherein, under a first-level category “1. Car category”, there are also included eight second-level categories, i.e., 1.1. Car for sale, 1.2. Second-hand car trade, 1.3. Car rental, 1.4. After-sales repair and maintenance, 1.5. Car insurance, 1.6. Car accessories, 1.7. Violation, and 1.8. Illegality.

TABLE 1

| First-level category | Second-level category |
|---|---|
| 1. Car category | |
| | 1.1. Car for sale; |
| | 1.2. Second-handcar trade; |
| | 1.3. Car rental; |
| | 1.4. After-sales repair and maintenance; |
| | 1.5. Car insurance; |
| | 1.6. Car accessories; |
| | 1.7. Violation; |
| | 1.8. Illegality. |

The process of determining classification above is illustrated in detail with reference to Table 2 below by taking one message as an example. In this embodiment, keywords and their numbers have already been pre-loaded in the analyzing module. Those keywords and their numbers include Guangzhou HONDA 1.0.0, Fit 1.0.0, Car purchase 1.1.0, Exhibition Hall 1.0.0, Test drive 1.1.0, etc. A number behind each keyword represents respective level categories corresponding to the keyword. For example, for Car purchase 1.1.0, the first “1” represents belonging to the first big category “Car category” in the first-level category; the second “1” represents belonging to the first small category “Car for sale category” in the second-level category corresponding to the car category (the seller sells car to a user); the third “0” represents that the third number is “0” because there is no sub-category (third-level category) under the “Car for sale category”. At the same time, the weighted values of the keyword for corresponding categories may also be obtained in turn: for the keyword Car purchase 1.1.0, the weighted value for the first-level category is 1, and the weighted value for the second-level category is 1+1. Since the first-level category always contains the second-level category, the weighted value of the second-level category is calculated by adding the weighted value of the first-level category containing it to the weighted value of the second-level category itself.

TABLE 2

| | Keywords obtained by | Keywords obtained by |
|---|---|---|
| | scanning when | scanning when |
| | determining the | determining the |
| Message content | first-level category | second-level category |
| Fit special sales event | Guangzhou HONDA | Car purchase 1.1.0; |
| will be held in | 1.0.0; | Exhibition Hall 1.1.0; |
| Guanazhou HONDA | Fit 1.0.0; | Test drive 1.1.0; |
| Sanhe Shop this | Car purchase 1.1.0; | |
| weekend for celebrating | Exhibition Hall 1.0.0; | |
| Valentine's Day; you | Test drive 1.1.0; | |
| can save cash in car | | |
| purchase and will be | | |
| additionally gifted with a | | |
| special ordered | | |
| diamond ring valued | | |
| 5213 RMB; please | | |
| recommend this to | | |
| others or come to the | | |
| exhibition hall for | | |
| personal test drive. For | | |
| more information please | | |
| call 85175588. | | |

In the case that the first-level category of the message cannot be determined according to the number of the message, the first-level category should be determined firstly as follows: scanning all keywords of respective categories in the short message. Five keywords of car category, i.e., “Guangzhou HONDA”, “Fit”, “Car purchase”, “Exhibition Hall” and “Test drive”, are found in the short message totally. A weighted sum of these keywords belonging to the first-level category “Car category” is 1+1+1+1+1=5, which exceeds a threshold value 4 set for “Car category”. Therefore, the first-level category is “Car category”.

Next, the second-level category is determined as follows: performing classification in second-level categories corresponding to the car category. All keywords of the second-level categories of the car category are scanned and “Car purchase”, “Exhibition Hall” and “Test drive” are found in the short message. A weighted sum of these keywords corresponding to the second-level category “Car for sale category” is “(1+1)+(1+1)+(1+1)=6”, which exceeds a threshold 4 for “Car for sale category”. Therefore, the second-level category is “Car for sale category”.

Thus, finally obtained category information of the short message is 1.1, i.e., to belonging to the second-level category “Car for sale category” in the first-level category “Car category”.

The example above only provides an exemplary classification method. In fact, the way of numbering keywords, the way of setting and calculating weighted values and the setting of threshold etc. may be modified according to the practical application.

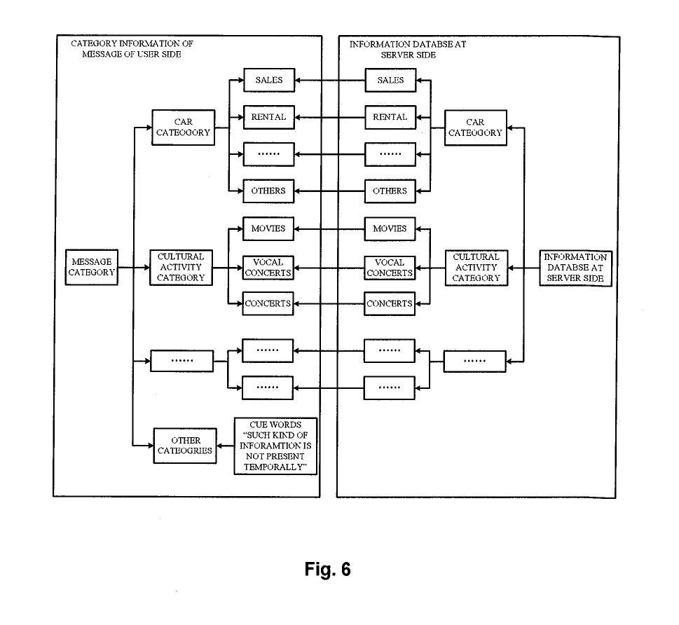

FIG. 6 shows a diagram of correspondences between information returned by a server side apparatus and message categories of a user side.

The server side apparatus 2 will returns corresponding information according to the information category transmitted from the user side apparatus 1. According to a preset category system, the information can belong to multiple big categories (first-level categories) such as car, cultural activity, bank and others, etc., and each big category has several small categories (second-level categories). For example, the category “Car” includes multiple small categories such as sale, rental, car insurance and others, etc. For the category “others” in the first-level category, the server side apparatus 2 only returns simple cue words, such as “Such kind of information is not present temporally”, or does not return any information. For other first-level categories or second-level categories, the server side apparatus 2 will return corresponding information therefrom according to the category of the message, so as to meet the interests and requirements of users while completing accurate information provision.

Here, the so-called “message” includes many categories such as short messages, on-line instant messaging, emails etc. The so-called “information” includes a variety of information such as advertisements, news, seller information etc. The “message” and “information” may have different data formats.

In the case that the analyzing module is located at the user side, in the process of data interaction between the user side apparatus and the server side apparatus, a transmitting apparatus of the user side apparatus may perform suitable processes such as assembling, compressing, encrypting etc. on the category information of the message and user related information, and then transmit the processed data to the server side apparatus over a network. After receiving the data, a server side receiving apparatus processes the data by using corresponding decrypting, decompressing, parsing etc., to obtain the category information of the message and the user related information in the data, and searches in a server side database according to the category information of the message, to obtain several pieces of information corresponding to the category information. A server side transmitting apparatus may perform processes such as assembling, compressing, encrypting etc. on the information, and then transmit the processed information to the user side apparatus over the network. A user side receiving apparatus may obtain the information by corresponding processes such as decrypting, decompressing, parsing etc. and may display the information on the user side interface.

In the case that the analyzing module is located at the server side, in the process of data interaction between the user side apparatus and the server side apparatus, the transmitting apparatus of the user side apparatus may perform suitable processes such as assembling, compressing, encrypting etc. on the message content and user related information, and then transmit the processed data to the server side apparatus over a network. After receiving the data, the server side receiving apparatus processes the data by using corresponding decrypting, decompressing, parsing etc., to determine the category information of the message and the user related information in the data, and searches in the server side database according to the category information of the message to obtain several pieces of information corresponding to the category information. The server side transmitting apparatus may perform processes such as assembling, compressing, encrypting etc. on the information, and then transmit the processed information to the user side apparatus over the network. The user side receiving apparatus may obtain the information by corresponding processes such as decrypting, decompressing, parsing etc. and may display the information on the user side interface.

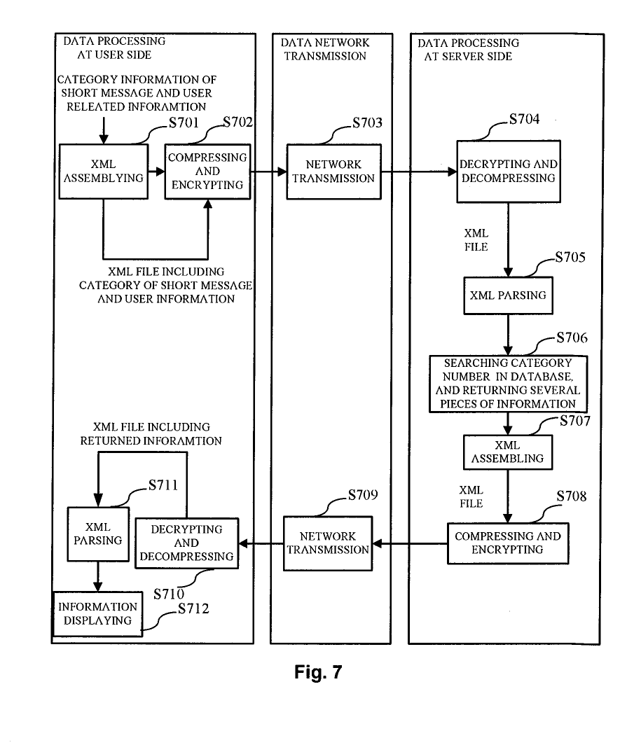

FIG. 7 shows an exemplary flowchart of an embodiment of data interaction between a user side apparatus and a server side apparatus. In the specific embodiment, a short message is classified at the user side according to the process described above by taking a short message based advertising service as an example. The user side apparatus firstly assembles category information of the short message and the user related information to an XML file (S701), then compresses and encrypts the file by using for example a deflate compression algorithm and an md5 encryption algorithm respectively (S702), and transmits data to the server side apparatus over a network, for example, gprs or wifi (S703). After receiving the data, the server side apparatus performs decrypting and decompressing processes respectively by using for example an md5 decryption algorithm and an inflate decompression algorithm respectively (S704) to obtain the original XML file. The server side apparatus performs XML parsing process (S705) to obtain the user information and category information of the short message contained in the XML file. The server side apparatus may search in an advertising information database according to a category number of the short message (S706), assembles the searched several pieces of (the number is 5 by default, which may be altered according to the setting by the user) advertising information (including an advertisement title, brief content and a detailed link) of the category to be in a format of XML file (S707). After compressing and encrypting the assembled information (S708), the server side apparatus transmits it to the user side apparatus (S709). The user side apparatus performs decrypting and decompressing processes (S710) and XML parsing (S711), and may display the advertising information on the user side interface (S712) to be selected and viewed by the user.

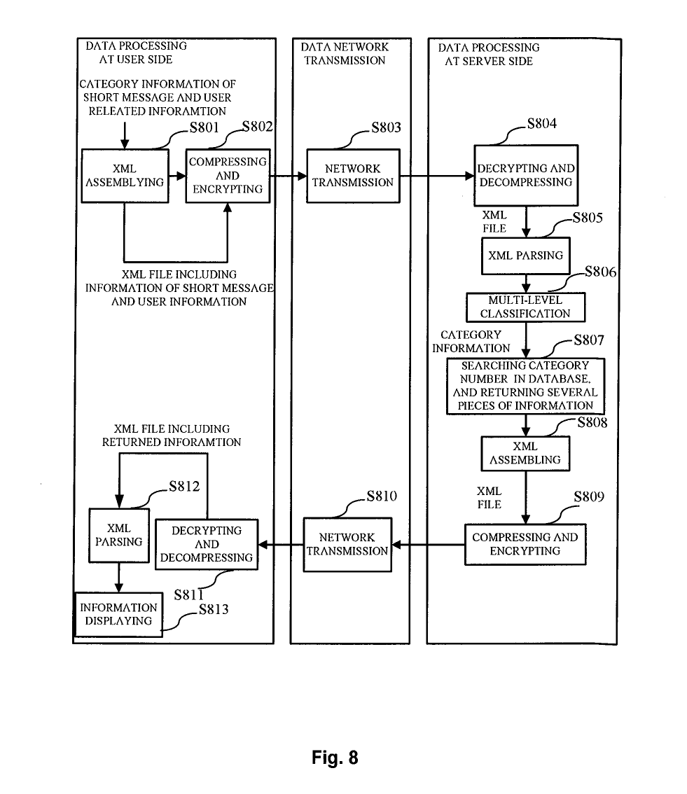

FIG. 8 shows an exemplary flowchart of another embodiment of data interaction between the user side apparatus and the server side apparatus. In the specific embodiment, a short message is classified at the server side according to the process described above by taking a short message based advertising service as an example. The user side apparatus firstly assembles the content of the short message and the user related information to an XML file (S801), then compresses and encrypts the file by using for example a deflate compression algorithm and an md5 encryption algorithm respectively (S802), and transmits data to the server side apparatus over a network, for example, gprs or wifi (S803). After receiving the data, the server side apparatus performs decrypting and decompressing processes respectively by using for example an md5 decryption algorithm and an inflate decompression algorithm respectively (S804) to obtain the original XML file. The server side apparatus performs XML parsing process (S805) to determine the user information and category information of the short message contained in the XML file. The server side apparatus performs multi-classification on the short message (S806) to obtain the category information of the short message. The server side apparatus searches in an advertising information database according to a category number of the short message and returns a plurality of pieces of information (S807). The server side apparatus assembles the searched several pieces of (the number is 5 by default, which may be altered according to the setting by the user) advertising information (including an advertisement title, brief content and a detailed link) of the category to be in a format of XML file (S808). After compressing and encrypting the assembled information (S809), the server side apparatus transmits it to the user side apparatus (8810). The user side apparatus performs decrypting and decompressing processes (S811) and XML parsing (S812), and then may display the advertising information on the user side interface (S813) to be selected and viewed by the user.

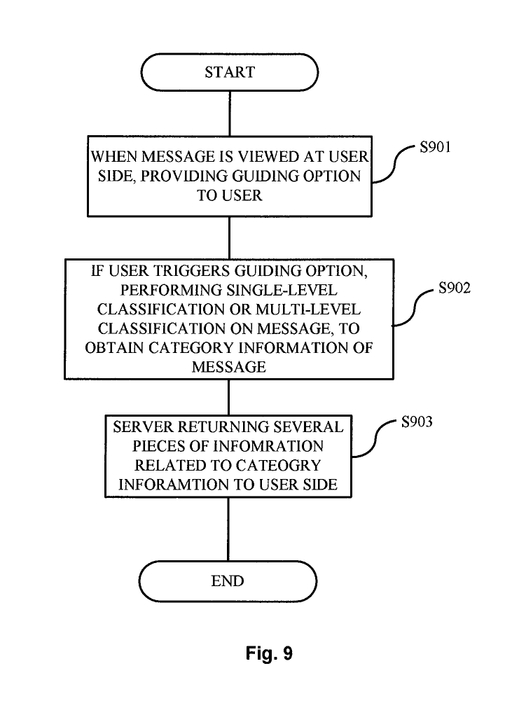

FIG. 9 shows a flowchart of an information recommendation method based on message content according to the present disclosure. The method comprises:

step S901, when a message is viewed on a user side, providing a guiding option such as “I am interested” or “View information of the same category” to a user;

step S902, if the user triggers the guiding option, performing single-level classification or multi-level classification on the message to obtain category information of the message;

step S903, a server returning several pieces of information related to the category information, possibly including the information itself or corresponding links, to the user side to be viewed by the user, thereby finally completing information recommendation.

The classifying process in step S902 is described below by taking two-level classification as an example. Those skilled in the art should understand that the classifying process may be extended to multi-level classification with more than two levels. The classifying process comprises the following steps:

S9021, pre-processing the message, for example, removing “noise information” such as punctuations;

S9022, then judging the transmission number of the message, and if a first-level category of the message is determined after the judgment, proceeding to step S9023; otherwise, proceeding to step S9024;

S9023, scanning the message by using keywords corresponding to respective second-level categories of the determined first-level category, wherein, the essence of the scanning process is to find keywords of second-level categories contained in the message (repeated keyword are omitted); since each keyword has a weighted value, calculating a sum of weighted values of the keywords corresponding to respective second-level categories in the message as a weighted sum of the respective second-level categories, and if a weighted sum of a certain second-level category reaches or exceeds a threshold value set for the second-level category, determining that the message belongs to the second-level category;

S9024, if the first-level category of the message cannot be determined after the judgment of the transmission number of the message, making a determination as follows: scanning the message by using all keywords in turn according to an order of respective first-level categories to find which keywords of respective second-level categories are contained in the message (repeated keywords are omitted); calculating a sum of weighted values of the keywords corresponding to respective first-level categories in the message as a weighted sum of the respective first-level categories, and if a weighted sum of a certain first-level category reaches or exceeds a threshold value set for the first-level category, determining that the message belongs to the first-level category and proceeding to S9025, and if there is no weighted sum of a first-level category that reaches or exceeds the threshold value set for the first-level category, determining that the message belongs to another category;

S9025, after the first-level category of the message is determined, determining the second-level category of the message by the same method as that of step S9023 to obtain the final message classification information, and the process ending.

Preferably, in step S9024, in the process of scanning the message by using all keywords in turns according to an order of the respective first-level categories, a sum of the weighted values of keywords corresponding to respective first-level categories in the message, which have been obtained by scanning, are calculated simultaneously as a weighted sum of the respective first-level categories; once a weighted sum of a certain first-level category reaches or exceeds a threshold value set for the first-level category, it is determined that the message belongs to the first-level category and the scanning is stopped at the same time, thereby completing the judgment of first-level category while shortening the time required by the judgment.

The above embodiments are used to exemplarily illustrate the principle of the present disclosure and the effect thereof instead of limiting the present disclosure. Those of ordinary skill in the art can make modifications to the above embodiments without departing from the spirit and scope of the present disclosure. Therefore, the protection scope of the present disclosure should be limited by the claims of the present disclosure.

1. An information recommendation method based on message content, comprising:
A) providing a guiding option to a user when a message is viewed at a user side;
B) if the user triggers the guiding option, performing single-level classification or multi-level classification on the message to obtain category information; and
C) the server returning information related to the category information to the user side.

2. The method according to claim 1, wherein the multi-level classification includes two-level classification, which comprises:
B1) pre-processing the message to remove noise information; and
B2) judging a transmission number of the message, and if a first-level category of the message is determined after the judgment, performing a second-level category judgment, which comprises:
scanning the message by using keywords corresponding to respective second-level categories of the determined first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and
if a weighted sum of a certain second-level category reaches or exceeds a threshold value set for the second-level category, determining that the message belongs to the second-level category.

3. The method according to claim 1, wherein the multi-level classification includes two-level classification, which comprises:
B1) pre-processing the message to remove noise information; and
B2) judging a transmission number of the message, and if a first-level category of the message cannot be determined after the judgment of the transmission number of the message, performing the following judgment which comprises:
scanning the message by using all keywords in turns according to an order of respective first-level categories to find keywords of the first-level categories contained in the message;
calculating a sum of weighted values of keywords corresponding to respective first-level categories in the message as a weighted sum of the respective first-level categories, wherein, repeated keywords are omitted and
if a weighted sum of a certain first-level category reaches or exceeds a threshold value set for the first-level category, determining that the message belongs to the first-level category, and performing a second-level category judgment,
wherein, the second-level category judgment comprises:
scanning the message by using keywords corresponding to respective second-level categories of the determined first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and
if a weighted sum of a certain second-level category reaches or exceeds a threshold value set for the second-level category, determining that the message belongs to the second-level category.

4. The method according to claim 1, wherein the multi-level classification includes two-level classification, which comprises:
B1) pre-processing the message to remove noise information; and
B2) judging a transmission number of the message, and if a first-level category of the message is determined after the judgment, performing a second-level category judgment, which comprises:
scanning the message by using keywords corresponding to respective second-level categories of the determined first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and
if a weighted sum of a certain second-level category reaches or exceeds a threshold value set for the second-level category, determining that the message belongs to the second-level category.

5. The method according to claim 1, wherein the multi-level classification includes two-level classification which comprises:
B1) pre-processing the message to remove noise information; and
B2) judging a transmission number of the message, and if a first-level category of the message cannot be determined after the judgment of the transmission number of the message, performing the following judgment which comprises:
in the process of scanning the message by using all keywords in turns according to an order of respective first-level categories, simultaneously calculating a sum of weighted values of keywords corresponding to respective first-level categories in the message, which have been obtained by scanning, as a weighted sum of the respective first-level categories;
once a weighted sum of a certain first-level category reaches or exceeds a threshold value set for the first-level category, determining that the message belongs to the first-level category and stopping the scanning at the same time, thus completing the judgment of the first-level category and performing a second-level category judgment; and
if there is no weighted sum of a first-level category that reaches or exceeds the threshold value set for the first-level category, determining that the message belongs to another category, and the second-classification ending,
wherein, the second-level category judgment comprises:
scanning the message by using keywords corresponding to respective second-level categories of the determined first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and
if a weighted sum of a certain second-level category reaches or exceeds a threshold value set for the second-level category, determining that the message belongs to the second-level category.

6. The method according to claim 2, wherein the keywords, the weighted values and the threshold values are selected and set by manually analyzing a number of messages in advance.

7. The method according to claim 2, wherein the keyword is numbered to represent its category and weighted value.

8. The method according to claim 1, wherein the message and the information have different data formats.

9. An information recommendation system based on message content, comprising a user side apparatus (1) and a server side apparatus (2), wherein,
the user side apparatus (1) comprises a user side receiving module (101), a user side interface (102), a guiding module (103), an analyzing module (104) and a user side transmitting module (105), and the sever side apparatus (2) comprises a server side receiving module (106), a server side transmitting module (107) and a database (108);
when a message is viewed on the user side apparatus (1), the guiding module (103) provides a guiding option and displays the guiding option on the user side interface (102), and if a user triggers the guiding option, a classifier in the analyzing module (104) starts to perform single-level classification or multi-level classification on the message to obtain category information, and the user side transmitting module (105) transmits the category information to the server side apparatus (2); and
the sever side receiving module (106) receives the category information, and information related to the category information in the database (108) is returned to the user side apparatus (1) by the server side transmitting module (107).

10. The system according to claim 9, wherein the classifier performs two-level classification on the message,
wherein a keyword and category information corresponding to the keyword are pre-loaded in the classifier, after the message enters the classifier, the message is pre-processed firstly to remove noise information in the message, then a transmission number of the message is judged, and if a first-level category of the message is determined after the judgment, a second-level category of the message continues to be determined,
wherein, determining the second-level category of the message comprises:
scanning the message by using keywords corresponding to respective second-level categories of the first-level category to find keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and
if a weighted sum of a certain second-level category reaches or exceeds a threshold value set for the second-level category, determining that the message belongs to the second-level category.

11. The system according to claim 9, wherein the classifier performs two-level classification on the message,
wherein a keyword and category information corresponding to the keyword are pre-loaded in the classifier, after the message enters the classifier, the message is pre-processed firstly to remove noise information in the message, then a transmission number of the message is judged, and if a first-level category of the message cannot be determined after the judgment of the number of the message, the message is scanned by using all keywords in turns according to an order of respective first-level categories, a sum of weighted values of keywords corresponding to respective first-level categories in the message is calculated as a weighted sum of the respective first-level categories, and if a weighted sum of a certain first-level category reaches or exceeds a threshold value set for the first-level category, it is determined that the message belongs to the first-level category; after the first-level category of the message is determined, a second-level category is then determined, and if there is no weighted sum of a first-level category that reaches or exceeds the threshold value set for the first-level category, it is determined that the message belongs to another category, and
wherein, determining the second-level category comprises:
scanning the message by using keywords corresponding to respective second-level categories of the first-level category to find keywords of second-level categories contained in the message;
according to a weighted value of each keyword, calculating a sum of weighted values of the keywords corresponding to the respective second-level categories in the message used as a weighted sum of the respective second-level categories, wherein, repeated keywords are omitted; and
if a weighted sum of a certain second-level category reaches or exceeds a threshold value set for the second-level category, determining that the message belongs to the second-level category.

12. The system according to claim 9, wherein the user side transmitting module assembles, compresses and encrypts the category information of the message and user related information to obtain transmitted data, then transmits the transmitted data to the server side apparatus over a network, after receiving the data, the sever side receiving module decrypts, decompresses and parses the transmitted data correspondingly to obtain the category information and the user related information, searches in the database according to the category information to obtain a plurality of pieces of information corresponding to the category information, the server side transmitting module assembles, compresses and encrypts the plurality of pieces of information and transmits the information to the user side apparatus over the network, and the user side receiving module obtains the plurality of pieces of information by corresponding decrypting, decompressing and parsing, and displays the information on the user side interface.

13. An information recommendation system based on message content, comprising a user side apparatus (1) and a server side apparatus (2), wherein,
the user side apparatus (1) comprises a user side receiving module (101), a user side interface (102), a guiding module (103) and a user side transmitting module (105), and the sever side apparatus (2) comprises a server side receiving module (106), an analyzing module (104), a server side transmitting module (107) and a database (108);
the guiding module (103) provides a guiding option to a user and displays the guiding option on the user side interface (102);
when the user triggers the guiding option, the user side transmitting module (105) transmits the message content to the server side apparatus (2);
the analyzing module (104) of the server side apparatus (2) comprises a classifier, which performs single-level classification or multi-level classification on the message to obtain category information, and
the server side transmitting module (107) returns information related to the category information in the database (108) to the user side apparatus (1).

14. The system according to claim 13, wherein the classifier performs two-level classification on the message,
wherein a keyword and category information corresponding to the keyword are pre-loaded in the classifier, after the message enters the classifier, the message is pre-processed firstly to remove noise information in the message, then a transmission number of the message is judge, and if a first-level category of the message is determined after the judgment, a second-level category of the message continues to be determined,
wherein, determining the second-level category of the message comprises:
scanning the message by using keywords corresponding to respective second-level categories of the first-level category to find the keywords of second-level categories contained in the message;
according to a weighted value of each keyword, calculating a sum of weighted values of the keywords corresponding to the respective second-level categories in the message as a weighted sum of the respective second-level categories, wherein, repeated keywords are omitted; and
if a weighted sum of a certain second-level category reaches or exceeds a threshold value set for the second-level category, determining that the message belongs to the second-level category.

15. The system according to claim 13, wherein the classifier performs two-level classification on the message,
wherein a keyword and category information corresponding to the keyword are pre-loaded in the classifier, after the message enters the classifier, the message is pre-processed firstly to remove noise information in the message, then a transmission number of the message is judged, and if a first-level category of the message cannot be determined after the judgment of the number of the message, in the process of scanning the message by using all keywords in turns according to an order of respective first-level categories, a sum of weighted values of keywords corresponding to respective first-level categories in the message, which have been obtained by scanning, is calculated simultaneously as a weighted sum of the respective first-level categories, once a weighted sum of a certain first-level category reaches or exceeds a threshold value set for the first-level category, it is determined that the message belongs to the first-level category and the scanning is stopped at the same time, thus completing the judgment of first-level category, and after the first-level category of the message is determined, a second-level category is then determined, and if there is no weighted sum of a first-level category that reaches or exceeds the threshold value set for the first-level category, it is determined that the message belongs to another category, and
wherein, determining the second-level category comprises:
scanning the message by using keywords corresponding to respective second-level categories of the first-level category to find the keywords of the second-level categories contained in the message;
according to a weighted value of each keyword, calculating a sum of weighted values of the keywords corresponding to the respective second-level categories in the message as a weighted sum of the respective second-level categories, wherein, repeated keywords are not calculated; and
if a weighted sum of a certain second-level category reaches or exceeds a threshold value set for the second-level category, determining that the message belongs to the second-level category.

16. The system according to claim 13, wherein the user side transmitting module assembles, compresses and encrypts the message content and user related information to obtain transmitted data, then transmits the transmitted data to the server side apparatus over a network, after receiving the data, the sever side receiving module decrypts, decompresses and parses the transmitted data correspondingly to determine the category information and the user related information, searches in the database according to the category information to obtain a plurality of pieces of information corresponding to the category information, the server side transmitting module assembles, compresses and encrypts the plurality of pieces of information and transmits the information to the user side module over the network, and the user side receiving apparatus obtains the plurality of pieces of information by corresponding decrypting, decompressing and parsing, and displays the information on the user side interface.

17. The method according to claim 3, wherein the keywords, the weighted values and the threshold values are selected and set by manually analyzing a number of messages in advance.

18. The method according to claim 4, wherein the keywords, the weighted values and the threshold values are selected and set by manually analyzing a number of messages in advance.

19. The method according to claim 5, wherein the keywords, the weighted values and the threshold values are selected and set by manually analyzing a number of messages in advance.
